(19) United States
(12) Patent Application Publication
(10) Pub. No.: US 2006/0139167 A1
(43) Pub. Date: Jun. 29, 2006

(54) Object positioning system, object positioning apparatus and object positioning method

(76) Inventors: Alan J. Davie, East Grinstead (GB); David M.J. Simons, Redhill (GB)

Correspondence Address: PHILIPS INTELLECTUAL PROPERTY & STANDARDS, P.O. BOX 3001, BRIARCLIFF MANOR, NY, 10510, US

(21) Appl. No.: 10/538,564

(22) PCT Filed: Dec. 9, 2003
(86) PCT No.: PCT/IB03/05834

§ 371 Date: Jun. 15, 2005

(30) Foreign Application Priority Data
Dec. 19, 2002 (GB) 0229690.3

(51) Int. Cl. G08B 1/08; G06Q 30/00; G08B 13/14; G08B 5/22

(52) U.S. Cl. 340/539.13; 340/572.1; 340/825.49; 235/385

(57) ABSTRACT

An object positioning system (100) for tracking the location of an object (142) comprises a base station (120) including a computer (124) coupled to at least a first receiver (122). The object (142) is fitted with a tag (140) having a limited signal transmission range, which is typically too weak to be directly received by the first receiver (122). A user (180) wears a portable transceiver (160), which activates the base station (120) by means of an object-related signal when within reception range of the signal transmitted by the tag (140). The computer (124) determines the location of the portable transceiver (160) worn by the user (180), and associates this position with the position of the object (142). As soon as the user (180) moves outside the signal transmission range of the tag (140), the object-related signal is terminated and the last known position of the portable transceiver (160) is used as the new location of the object (142).

The present invention relates to an object positioning system and to a method for positioning an object.

Object positioning systems, that is, systems that are registering or determining the position of an object by means of a base station, are becoming increasingly popular. One example of such a system is the global positioning system (GPS), where the position of an object like a car, ship or a person is being determined by performing a triangulation measurement on the signals received from a number of satellites with known positions. This way, a is regular update of the position of the object is obtained. However, GPS is a complex, expensive technique, and its application is far from trivial in an indoor environment. Consequently, alternatives have been developed for low-cost as well as for indoor usage.

U.S. Pat. No. 6,483,427 describes an object tracking system. In this system, a plurality of distributed transceivers are arranged to keep in constant communication with an object tagged with a radio frequency (RF) tag. The tag modulates the signal that it receives from the transmitters in the system in order to allow the system to identify this particular tag and discriminate between the various tags under surveillance. The location of the tag is being determined by proximity and triangulation techniques. This location technique, that is, the technique where objects are being kept under surveillance by means of the transmission of polling signals by one or more base stations, is a well-known and widely adopted technique, especially in the field of RF signal based positioning.

However, there are several disadvantages attached to these polling approaches. First of all, they are not very power-efficient; the transceivers in the system keep in more or less constant contact with the objects under surveillance, even though the object may be stationary for most of the time. Furthermore, because the distance between the transceivers and the tags under surveillance is unknown beforehand, the tags attached to the objects have to generate a relatively strong signal to be able to reach the transceivers in situations where the tags are placed far away from the transceivers. Consequently, the tags often are quite sizeable, which is a serious drawback in certain application domains like a domestic environment, where large tags may be undesirable for both practical and aesthetic reasons.

Amongst others, it is a first object of the invention to provide an object positioning system wherein unnecessary base station polling can be avoided.

It is a second object of the invention to provide for an object positioning apparatus for use in the object positioning system of the invention.

It is a third object of the invention to provide an object positioning method for avoiding unnecessary base station polling.

Now, the first object of the invention is realized by an object positioning system, comprising a first base station for determining a location of an object based upon an object-related signal; an object-attachable tag; and a portable transceiver, comprising a receiver arrangement for receiving a signal from the tag; a signal processor for converting the signal into the object-related signal; and a transmitter arrangement for sending the object-related signal to the first base station.

The invention is based on the realization that, apart from rare accidental displacements, objects under surveillance by an object positioning system typically are displaced by a user of the system, for instance, by an employee on the floor of a factory or warehouse, or by an inhabitant of a domestic environment. According to the invention, an object under surveillance is fitted with a tag having a limited signal transmission range that is typically too small to reach the base station directly. The user of the system has to wear or carry around the portable transceiver, which is only capable of receiving a communication from the tagged object when the user is close, like at arms length, to the object. In response to this established communication, the portable transceiver is arranged to notify the first base station, which typically includes a receiver or transceiver coupled to a database, of the established communication. Consequently, the base station no longer has to poll the tag, but can just listen to the transmission frequency of the portable transceiver to detect the displacement of an object. As soon as the communication between the tag and the portable transceiver is terminated because the user has moved outside the transmission range of the tag, the first base station registers the last known position of the portable transceiver, because this was the last known position where the user was close to the object. This way, the position of the object is determined by means of associating its position with that of the portable transceiver worn by the user.

An additional advantage of this arrangement is that the tags can be kept very small because their transmissions only have to cover a very limited area, which allows for the use of the tags in more application domains, like the domestic environment. The coverage of the very limited area has the further advantage that the tags use little power, which enhances the lifetime of the tags. Also, because the base station no longer has to poll to keep track of the object, the power consumption of the object positioning system is significantly reduced. Furthermore, omission of the need for polling means that far less radio traffic takes place within the system, which reduces the risk of interference with signals from other sources in the same frequency range.

In an embodiment of the present invention, the signal processor is arranged to include a transceiver identification code in the object-related signal. This has the advantage that, in a multiple transceiver environment, the object tracking system can tell which portable transceiver, that is, which user has been displacing the object. This can be particularly useful if an object is taken outside the service area of the base station, for instance when the object has been misplaced or even stolen by a user. For this reason, it may be advantageous to integrate the portable transceiver into a wearable item like an identification badge or a work overall to avoid the user taking the portable transceiver off while being in the vicinity of the objects under surveillance by the object positioning system.

Alternatively, the signal processor may comprise a signal amplifier, in which case the portable transceiver operates as an amplifier for the signal transmitted by the tag. To avoid collision between the signal received from the tag and the object-related signal, the portable transceiver may be arranged to delay the transmission of the object-related signal or may be arranged to transmit the object-related signal at a different frequency than the frequency of the signal from the tag. This is particularly advantageous in application domains where no portable transceiver-specific information is required.

Typically, several portable transceivers may be present within the object positioning system, in which case measures may be taken to avoid or reduce the risk of interference between simultaneous transmissions from different portable transceivers. In other words, at least a further portable transceiver comprising a further receiver arrangement for receiving the signal; a further signal processor for converting the signal into a further object-related signal; and a transmitter arrangement for sending the further object-related signal to the base station may be present in the object positioning system.

Therefore, in an embodiment of the present invention, the portable transceiver comprises an implementation of a signal transmission collision avoidance mechanism. An implementation of a collision avoidance mechanism like carrier sense multiple access collision avoidance (CSMA-CA) has the advantage that the chance of interference between simultaneous transmissions from different transceivers is reduced.

In another embodiment of the present invention, the transmitter arrangement is arranged to send the object-related signal at a first frequency, and the further transmitter arrangement is arranged to send the further object-related signal at a second frequency, the first frequency being different to the second frequency.

The use of frequency division multiple access techniques has the advantage that the risk of interference between simultaneous transmissions from different transceivers is reduced. Combination of this embodiment with a collision avoidance mechanism provides a further reduction of this risk.

In yet another embodiment of the present invention, the transmitter arrangement is arranged to send the object-related signal with a first synchronized delay upon receiving the signal, and the further transmitter arrangement is arranged to send the further object-related signal with a second synchronized delay upon receiving the signal, the first synchronized delay being different to the second synchronized delay.

The use of time division multiple access techniques has the advantage that the risk of interference between simultaneous transmissions from different transceivers is reduced. Combination of this embodiment with a collision avoidance mechanism provides a further reduction of this risk.

In a further embodiment of the present invention, the tag is a passive tag responsive to an activation signal and the portable transceiver comprises a further transmitter arrangement for providing the tag with the activation signal. This has the advantage that the tag does not have to send periodic signals to make a portable transceiver aware of its presence. However, the portable transceiver now has to use polling to detect the presence of the tagged object. This is, however, not a drawback, because the portable transceiver can simply be fitted with an on/off switch, which allows a carrier of the portable transceiver to switch it off when it is not being used. Alternatively, the portable transceiver may be fitted with a standby function to switch the portable transceiver to a low-power mode when being out of base station reach. In other words, this form of polling may only take place when a user of the system decides to enter the system, in which case the occurrence of unnecessary polling is minimal.

The object location techniques used by the object positioning system may be any known technique, such as determination of the location of the object, or rather the portable transceiver, by means of time of flight or signal strength determination in a triangulation measurement, in which case the object positioning system further comprises a second base station and a third base station; the first base station, the second base station and the third base station being arranged to cooperate in positioning the location of the object by means of a triangulation measurement of the object-related signal. Alternatively, a single base station may be used if the object positioning system determines the multi-path power delay profile of the object-related signal to obtain the fingerprint of the location the portable transceiver is in.

It will be understood that the second object of the present invention is realized by providing the aforementioned embodiments of the various object positioning apparatuses in the object positioning system, that is, separate base stations and separate portable transceivers or the combination of such articles for use in an object positioning system according to the present invention.

Now, the third object of the present invention is realized by a method of positioning a location of an object, the method comprising the steps of sending a signal from a tag to a portable transceiver; converting the signal to an object-related signal; sending the object-related signal to a base station; determining the position of the portable transceiver sending the object-related signal; and associating the position of the object with the determined position of the portable transceiver. According to the method of the present invention, the position of an object is associated with the position of the user carrying the portable transceiver. By relaying the signal through such a transceiver, long-range polling between the base station and the tag is avoided, which has the advantage that the method of the present invention is more power efficient than known object positioning methods.

In an embodiment, the step of sending the object related signal to a base station comprises the sub steps of sending a first part of the object-related signal upon establishing a communication with the tag; and sending a second part of the object related signal upon terminating the communication with the tag.

This has the advantage that portable transceiver specific information can be added to the object-related signal.

Advantageously, the step of sending a signal from a tag to a portable transceiver is preceded by activating the tag with an activation signal from the portable transceiver. Consequently, the tag does not have to send periodic signals to make itself detectable by the portable transceiver, which means that the tag does not have to be fitted with a power supply.

The invention is described in more detail and by way of non-limiting examples with reference to the accompanying drawings, wherein:

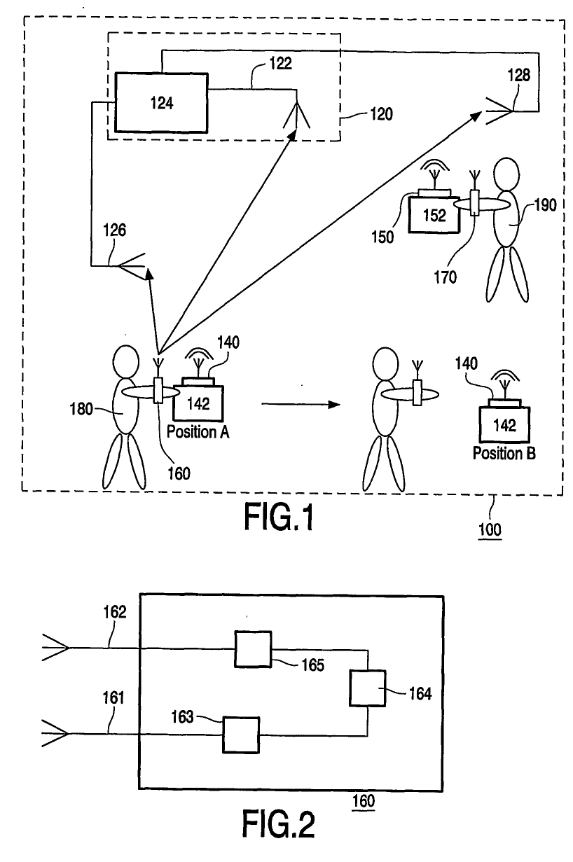

FIG. 1 depicts an embodiment of an object positioning method according to the present invention;

FIG. 2 depicts an embodiment of a portable transceiver according to the present invention; and

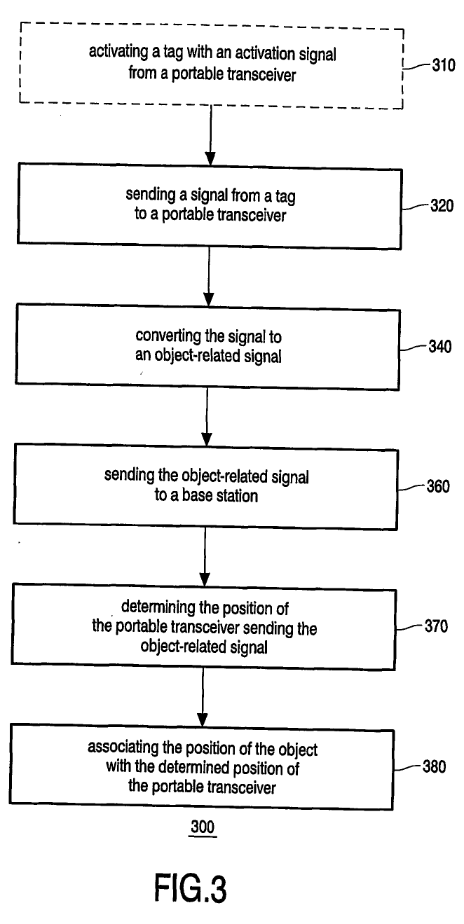

FIG. 3 depicts a flow chart of the object positioning method according to the present invention.

In FIG. 1, object positioning system 100 includes a first base station 120, which includes a receiver 122 coupled to a database 124. The database 124, which is used for registering the positions of the objects under surveillance, may be an implementation as simple as a collection of shift registers or may be implemented by means of a suitable programmed computer, or by any other known implementation of a database. The base station 120 may be used to locate the origin of a signal by means of a determination of the multi-path power delay profile of the signal. Alternatively, a triangulation measurement technique may be used based on the signal strength or the time-of-flight of the signal, in which case at least a second base station including a receiver 126 and a third base station including a third receiver 128 are required. Obviously, when time-of-flight techniques are being employed, receivers 122, 126 and 128 may be replaced by transceivers if the time-of-flight measurement is based on a signal originating from a base station like the base station 120. Alternatively, the time-of-flight measurement may be based on a signal originating from the device to be located, in which case synchronization between this device and a base station like base station 120 is required.

An object 142 is fitted with a tag 140, which may be either a passive or an active tag. In both cases, the tag typically has a small transmission range of no more than a few meters. If a relatively high accuracy of object location is required, the transmission range of the tag 140 may even be smaller. A user 180 of the object positioning system 160 wears a portable transceiver 160.

The portable transceiver 160 may for instance be integrated in a bracelet, necklace, identification bag or a garment, or may be a discrete device that for instance can be carried around in a pocket of the user 180 or can be clipped to a garment of the user 180. A schematic embodiment of a portable receiver for use in the object positioning system 100 like for instance the portable transceiver 160 is given in FIG. 2. The portable transceiver 160 has a receiver arrangement, including a reception (Rx) antenna 161 and a receiver 163, as well as an transmitter arrangement including a transmission (Tx) antenna 162 and a transmitter 165. Rx antenna 161 and Tx antenna 162 may be separate antennas or may be integrated into a single Rx/Tx antenna. The Rx antenna 161 is arranged to receive a signal from a tag like the tag 140 within the object positioning system 100. The signal from a tag like the tag 140 will typically include tag specific information like a tag identification code or object information that is programmed into the tag, although other information is feasible as well. The Rx antenna 161 is coupled to a receiver 163. The receiver 163 may be any known receiver, and may include a bandpass filter, an analog-to-digital converter and a demodulator. The receiver 163 is coupled to an input of a signal processor 164. The signal processor 164 is arranged to convert the signal to an object-related signal, and may include a modulator for modulating transceiver specific information like an identification code into the object-related signal.

The object-related signal is provided to a transmitter 165, which may be any known transmitter, and which may include a modulator, a digital-to-analog converter and a bandpass filter. The transmitter 165 may be arranged to output the object-related signal to Tx antenna 162 at a frequency specific to the portable transceiver 160 as a part of a frequency division multiple access protocol used by object positioning system 100 in order to reduce the risk of the loss of object-related signals by interference with for instance other object-related signals. Alternatively, the signal processor 164 may be arranged to dynamically define the frequency of the object-related signal in response to the assignment of a frequency by the base station 120. As a further alternative, the signal processor 164 may be arranged to introduce a synchronized delay to the output of the object-related signal to the transmitter 165 as a part of a time division multiple access protocol used by object positioning system 100. This synchronized delay may be a fixed delay, which may be implemented by a delay path, or may be dynamically defined by assignment of the delay period by the base station 120. The synchronization may be provided by synchronized clocks on board the portable transceivers, or by a synchronization signal provided by the base station 120. The portable transceiver 160 may also implement a collision avoidance technique like CSMA-CA, which may be combined with the aforementioned techniques for avoiding interference between the object-related signal and other signals.

The signal path between the receiver 163 and the signal processor 164 as well as the signal path between the signal processor 164 and the transmitter 165 may include amplifiers to boost the signal and/or the object-related signal. The signal processor 164 itself may also be a signal amplifier, in which case the amplifiers in the aforementioned signal paths may be omitted. To avoid collision between the incoming signal from the tag and the object-related signal, the portable transceiver 160 may be arranged to delay the transmission of the object-related signal, or to transmit the object-related signal at a frequency that is different to the frequency of the received signal.

The portable transceiver 160 may also be arranged to generate a periodic activation signal for waking up a tag in the case a tag like tag 140 is a passive tag. The activation signal may be provided via Tx antenna 162 or via another Tx antenna not shown. In this embodiment, it may be useful to add an on/off switch not shown to the portable transceiver 160, to avoid unnecessary transmission of the activation signal. Alternatively, the on/off switch may be replaced by a standby mode, which may be enabled upon losing a connection with the base stations of the object positioning system 100. Obviously, the base station 120 and other base stations in the object positioning system 100 have to be fitted with transceivers for the portable transceiver 160 being able to determine the loss of such a connection. This way, the lifetime of the power supply like a battery of the portable transceiver 160 may be extended.

Also, the portable transceiver 160 may be fitted with a data storage for storing the position of the object. This is especially advantageous when the portable transceiver 160 is compatible with more than one object location system, in which case the positional information obtained in the one object location system can be uploaded into the other object location system when the latter system is being entered. Alternatively, the data storage of the transceiver tag 160 may be coupled to an output, which allows the positional information to be downloaded from the portable transceiver 160. This can be advantageous in situations where the object positioning system 100 is at a remote location like a warehouse at an industrial site or in a harbour, and the positional information has to be accessible by a database in a different location.

It is emphasized that these embodiments of the portable transceiver 160 are given by way of non-limiting example only, and that other known embodiments of transceivers are also plausible to be used within the object positioning system 100.

Now, on returning back to FIG. 1, if the user 180 wearing the portable transceiver 160 gets close to the object 142 fitted with the tag 140 for instance when the object 142 is being picked up by the user 180 in position A, the Rx antenna 161 of the transceiver tag picks up the signal of the tag, and the signal processor 164 of the portable transceiver 160 may generate a first part of the object-related signal, which is received by the receivers 122, 126 and 128, or just by the receiver 122 depending on the technique used for the object location by the object positioning system 100, as previously explained. The portable transceiver 160 may only send the object-related signal in response to a large enough change in the signal intensity of the signal from the tag 140, in which case the portable transceiver 160 only sends the object-related signal when approaching the object 142. This signal will notify the database 124 that an object is in the proximity of a user and is likely to be relocated. At this point, the database 124 may start to determine the origin of the object-related signal, and associates this origin with the location of the object 142.

After the user 180 has placed the object 142 fitted with the tag 140 in a position B and moves away from it, the generation of the tag signal induced object-related signal is terminated because the user is now outside the transmission range of the tag 140, and the database 124 will update the location of the object 142 based upon the last known origin of the object-related signal. At this point, a second part of the object-related signal may be generated signalling the termination of link between the portable transceiver 160 and the tag 140. Again, this second part of the object-related signal may only be generated upon a large enough change in the intensity of the signal received from the tag 140.

It is emphasized that in this context, a first part of the object-related signal may be a first object-related signal and the second part of the object-related signal may be a second object-related signal, and that the first part of the object related signal and the second part of the object related signal may be identical.

In fact, the transmission of the first part of the object-related signal upon establishing the link with the tag 140 may be omitted, and the portable transceiver 160 may only send the second part of the object-related signal upon termination of the link with the tag 140, making it even more power efficient. However, if a user 180 leaves the coverage area of the object positioning system 100, the object 142 will be lost to the object positioning system 100. Therefore, this embodiment is particularly useful in situations where there is little risk of the objects being moved outside the coverage area of the object positioning system 100. The use of one, two or, in general, only a few object-related signals to locate the position of an object has the advantage that it is very power-efficient.

Alternatively, the portable transceiver 160 may be arranged to continuously or periodically generate the object-related signal as long as the portable transceiver 160 is within reception range of the signal from the tag 140, in which case the object positioning system keeps updating the position of the object up until the point where the object-related signal terminates. This has the advantage that the object positioning based upon the object-related signal is less sensitive to interference because the object-related signal is broadcasted on a regular basis, which increases the chance of the signal actually reaching the base station 120.

Interference may be caused by the presence of another user 190 wearing a further portable transmitter 170, which typically will include a further receiver arrangement for receiving a signal from a further tag, like a tag 150 fitted to a further object 152, a further signal processor for converting the signal into a further object-related signal, and a transmitter arrangement for sending the further object-related signal to the base station. The embodiment of the further portable transceiver 170 preferably will be the same as that of the portable transceiver 160. To avoid or reduce the risk of interference, the portable transceiver 160 and the further portable transceiver 170 may be equipped with interference avoidance measures as described in the detailed description of FIG. 2.

When an unidentified portable transceiver or an unidentified tag enters the object positioning system 100, the relevant information of these new items may be dynamically added to the database 124 upon establishing a communication between such an item and the base station 120. Alternatively, such items may be added to the database 124 by manual programming. Typically, the information that is stored in a tag of an object will be stored in the database 124 together with the position of the object in the object positioning system 100, whereas in case of a new portable transceiver the identification code typically will be stored.

At this point, it is emphasized that the presence of a database 124, although not strictly necessary, is desireable, because this allows an evaluator of the object positioning system 100 not only to keep track of the position of the objects but it also provides valuable information about which user handled the objects to the evaluator. The latter information is particularly advantageous in situations where objects are moved outside the coverage area of the object positioning system 100, in which case it is retrievable which user was responsible for this event. This can for instance be used to reduce the risk of theft or loss of objects under surveillance.

Furthermore, it is once more emphasized that at least one of the receivers 122, 126 and 128 may be replaced by a transceiver, in order to enable duplex communication between the portable transceiver 160 and one of the base stations in the object positioning system 100. This is particularly advantageous when a tag like the tag 140 or the further tag 150 carries a plurality of data fields, which for instance may be individually retrieved by duplex communication between a portable transceiver 160 and the tag 140 in response to a request for information by one of the base stations in the object positioning system 100.

In FIG. 3, the object positioning method of the present invention is summarized in the form of a flow chart. In an optional first step 310, a passive tag is activated with an activation signal from a portable transceiver. This step can be omitted when active tags are being used, in which case the second step 320, the sending of a signal by the tag to the portable receiver, will take place directly as soon as the portable transceiver enters the transmission range of the tag. In a third step 340, the tag signal is converted to an object-related signal, which is being sent to a base station in a next step 360. This step 360 may comprise a first sub step of sending a first part of the object-related signal upon establishing a communication with the tag and a second sub step of sending a second part of the object related signal upon terminating the communication with the tag. Alternatively, the first substep may be omitted. Subsequently, the method comprises a step 370 of sending a first part of the object-related signal upon establishing a communication with the tag; and the method concludes with the step 380 of associating the position of the object with the determined position of the portable transceiver.

The steps 370 and 380 may be done on the basis of the second part of the object-related signal if step 360 comprises this aforementioned sub step of step 360. Thus, the object positioning method according to the present invention determines changes in the location of the object by associating the object location with the location of a user displacing the object, provided the user is wearing a portable transceiver for use in the object positioning method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to an advantage.

1. An object positioning system (100), comprising:
a first base station (120) for determining a location of an object (142, 152) based upon an object-related signal;
an object-attachable tag (140, 150); and
a portable transceiver (160), comprising:
a receiver arrangement (161; 163) for receiving a signal from the tag (140, 150);
a signal processor (164) for converting the signal into the object-related signal; and
a transmitter arrangement (162; 165) for sending the object-related signal to the first base station (120).

2. An object positioning system (100) as claimed in claim 1, wherein the first base station (120) comprises a receiver (122) coupled to a database (124).

3. An object positioning system (100) as claimed in claim 1, wherein the signal processor (164) is arranged to include a transceiver identification code in the object-related signal.

4. An object positioning system (100) as claimed in claim 1, wherein the signal processor (164) comprises a signal amplifier.

5. An object positioning system (100) as claimed in claim 1, wherein the portable transceiver (160) comprises an implementation of a signal transmission collision-avoidance mechanism.

6. An object positioning system (100) as claimed in claim 1, comprising a further portable transceiver (170); comprising:
a further receiver arrangement for receiving the signal;
a further signal processor for converting the signal into a further object-related signal; and
a further transmitter arrangement for sending the further object-related signal to the base station (120).

7. An object positioning system (100) as claimed in claim 6, wherein the transmitter arrangement (162) is arranged to send the object-related signal at a first frequency, and the further transmitter arrangement is arranged to send the further object-related signal at a second frequency, the first frequency being different to the second frequency.

8. An object positioning system (100) as claimed in claim 6, wherein the transmitter arrangement (162) is arranged to send the object-related signal with a first synchronized delay upon receiving the signal, and the further transmitter arrangement is arranged to send the further object-related signal with a second synchronized delay upon receiving the signal, the first synchronized delay being different to the second synchronized delay.

9. An object positioning system (100) as claimed in claim 1, wherein:
the tag (140, 150) is a passive tag responsive to an activation signal; and
the portable transceiver (160) comprises a further transmitter arrangement for providing the tag (140, 150) with the activation signal.

10. An object positioning system (100) as claimed in claim 1, further comprising a second base station (126) and a third base station (128); the first base station (120), the second base station (126) and the third base station (128) being arranged to cooperate in positioning the location of the object (142, 152) by means of a triangulation measurement of the object-related signal.

11. A base station (120) for use in an object positioning system (100) as claimed in claim 1, the base station (120) being arranged to track a location of an object responsive to an object-related signal from a portable transceiver.

12. A portable transceiver (160) for use in an object positioning system (100) as claimed in claim 1, the portable transceiver (160) comprising:
a receiver arrangement (161) for receiving a signal from a tag;
a signal processor (164) for converting the signal into an object-related signal; and
a transmitter arrangement (162) for sending the object-related signal to a first base station.

13. A portable transceiver (160) as claimed in claim 12, wherein the signal processor (164) is arranged to include a transceiver identification code in the object-related signal.

14. A portable transceiver (160) as claimed in claim 12, wherein the signal processor (164) comprises a signal amplifier.

15. A portable transceiver (160) as claimed in claim 12, wherein the portable transceiver (160) comprises an implementation of a collision-avoidance mechanism.

16. A portable transceiver (160) as claimed in claim 12, wherein the portable transceiver (160) comprises a further transmitter arrangement for providing the tag with an activation signal.

17. A portable transceiver (160) as claimed in claim 12, the portable transceiver (160) being integrated in a wearable item.

18. A portable transceiver as claimed in claim 12, comprising a data storage for storing the position of the object.

19. A method of positioning a location of an object (300), the method comprising the steps of:
sending a signal from a tag to a portable transceiver (320);
converting the signal to an object-related signal (340);
sending the object-related signal to a base station (360); and
determining the position of the portable transceiver sending the object-related signal (370); and
associating the position of the object with the determined position of the portable transceiver (380).

20. A method as claimed in claim 19, wherein the step of sending the object related signal to a base station (360) comprises the sub steps of:
sending a first part of the object-related signal upon establishing a communication with the tag; and
sending a second part of the object related signal upon terminating the communication with the tag.

21. A method as claimed in claim 19, wherein the step of sending a signal from a tag to a portable transceiver (320) is preceded by activating the tag with an activation signal from the portable transceiver (310).
